(19) United States
(12) Patent Application Publication
(10) Pub. No.: US 2019/0147667 A1
(43) Pub. Date: May 16, 2019

(54) SYSTEMS AND METHODS FOR VIRTUAL LINE SERVICES

(71) Applicant: Whyline, Inc., Brooklyn, NY (US)

(72) Inventors: Nicolas Susco, Rosario (AR); Patricio Romero, Rosario (AR); Gaston Frydlewski, Brooklyn, NY (US); Michael Twersky, New York, NY (US)

(21) Appl. No.: 15/814,117

(22) Filed: Nov. 15, 2017

(51) Int. Cl. G07C 1/02; H04L 29/08; G06F 3/0482

(52) U.S. Cl. CPC G07C 1/02; G07C 2011/04; G06F 3/0482; H04L 67/02

(57) ABSTRACT

The present invention is directed to methods for creating a virtual line at a place of interest, and for presenting congestion of a line at a place of interest. The methods include: receiving a request to enter a virtual line at a place of interest from a first individual; placing the first individual in the virtual line; tracking a check-in and -out time of the first individual in the virtual line; determining, based on the check-in and -out time, a congestion symbol of the virtual line; and presenting the congestion symbol to a second individual. The methods also include: receiving a request by an individual for a congestion indication for a first and second line at the first and second place of interest, respectively; determining the congestion indications for the first and second lines; and presenting the first and second congestion indications. Systems operating in similar fashion are disclosed herein.

### TECHNICAL FIELD

The present disclosure generally relates to systems and methods for virtual line services, and more specifically, to systems and methods for allowing individuals to determine wait times remotely from a place of interest and for virtually waiting in a line at the place of interest without physically being present.

### BACKGROUND

Today, people everyday waste time waiting in line for a number of different things. For example, people wait in line to buy tickets to concerts, gain admission to special events, and enter sport events. In sum, when the number of people at a place of interest exceeds its capacity to permit accommodation, a line results. The time for accommodation of an individual in a line can vary on the place of interest, and can range from minutes to hours. As such, the time for accommodation can be based on a number of variables, such as processing time, the amount of workers, the number of individuals waiting, etc.

As such, individuals have found it difficult to readily determine waiting times at places of interest at a given time of day. Likewise, places of interest have found it difficult to retain individuals who do not want to wait in line. Accordingly, it is difficult to retain individuals who wish to wait in line without wasting time. Embodiments of the present invention provide such systems and methods.

### SUMMARY OF THE INVENTION

In an embodiment of the present invention, a method for creating a virtual line for a place of interest is provided, including: receiving a first request to enter a virtual line at a place of interest from a first individual; placing the first individual in the virtual line; creating the virtual line with the first individual; tracking a check-in and check-out time of the first individual in the virtual line; determining, based on the check-in and check-out time, a congestion symbol of the virtual line; and presenting the congestion symbol of the virtual line to a second individual.

In another embodiment, a system for creating a virtual line for a place of interest is provided, including an administrator device configured to: receive a first request to enter a first virtual line at a place of interest from a first individual; place the first individual in the first virtual line; create the first virtual line with the first individual; track a check-in and check-out time of the first individual in the first virtual line; determine, based on the check-in and check-out time, a congestion symbol of the first virtual line; and present the congestion symbol of the first virtual line to a second individual.

In yet another embodiment, a method of presenting congestion of a line at a place of interest is provided, including: receiving place of interest data for a first and second place of interest from a first external server; receiving a request by an individual for a first congestion indication for a first line at the first place of interest to receive a second congestion indication for a second line at the second place of interest; determining the first congestion indication for the first line at the first place of interest and for the second line second place of interest; and presenting the first congestion indication of the first line at the first place of interest and the second congestion indication for the second line second place of interest. The first line only having one or more individuals physically waiting in the first line. The second line only having one or more individuals virtually waiting in the second line.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates an exemplary system that can be utilized to create a virtual line for a place of interest in accordance with embodiments of the present invention;

FIGS. 2-8 illustrate exemplary user interfaces for an administrator at the administrator device illustrated in FIG. 1 in accordance with embodiments of the present invention;

FIG. 9-14 illustrate exemplary user interfaces for an individual at a place of interest device illustrated in FIG. 1 in accordance with embodiments of the present invention;

FIG. 15-20 illustrate exemplary user interfaces for an individual using a personal device illustrated in FIG. 1 in accordance with embodiments of the present invention;

FIG. 21 illustrates an exemplary method to determine a wait time at a place of business in accordance with embodiments of the present invention;

FIG. 22 Illustrates an exemplary method create a virtual line for a place of interest in accordance with embodiments of the present invention; and

FIG. 23 illustrates a schematic diagram of an exemplary server that can be utilized in accordance with embodiments of the present invention.

### DETAILED DESCRIPTION OF THE PRESENT INVENTION

Reference will now be made in detail to various embodiments of the present invention, examples of which are illustrated in the accompanying drawings. It is to be understood that the figures and descriptions of the present invention included herein illustrate and describe elements that are of particular relevance to the present invention. It is also important to note that any reference in the specification to “one embodiment,” “an embodiment” or “an alternative embodiment” means that a particular feature, structure or characteristic described in connection with the embodiment is included in at least one embodiment of the invention. As such, the recitation of “in one embodiment” and the like throughout the specification does not necessarily refer to the same embodiment.

The systems and methods disclosed herein are intended to enable one or more individuals remote from a place of interest to receive a congestion indication at the place of interest and to wait in a virtual line at a place of interest permitting so. As such, the congestion indication at a place of interest may be received even if the place of interest does not have a virtual line. In circumstances where the place of interest has a virtual line, the individual can enter a virtual line by submitting a request on a device located at the place of interest (hereinafter “POI device”) or via their own personal device (hereinafter “personal device”). As such, the systems and methods disclosed herein can permit individuals to enter a line without physically forming a line and/or without being physically present at the place of interest during their wait.

The terms “congestion,” “congestion data,” and “congestion indication” refers to data relating to traffic in a place of interest and/or to an average time of an individual waiting in line at the place of interest.

The term “place of interest” used herein can refer to any location throughout the world, and can be across any industry.

The term “virtual line” used herein can refer to a line representing one or more individuals waiting virtually and/or waiting physically in a line at the place of interest. As such, the term “place of interest” can include one or more individuals accessing a line on a POI device of personal device, or by being present and forming a line at the place of interest

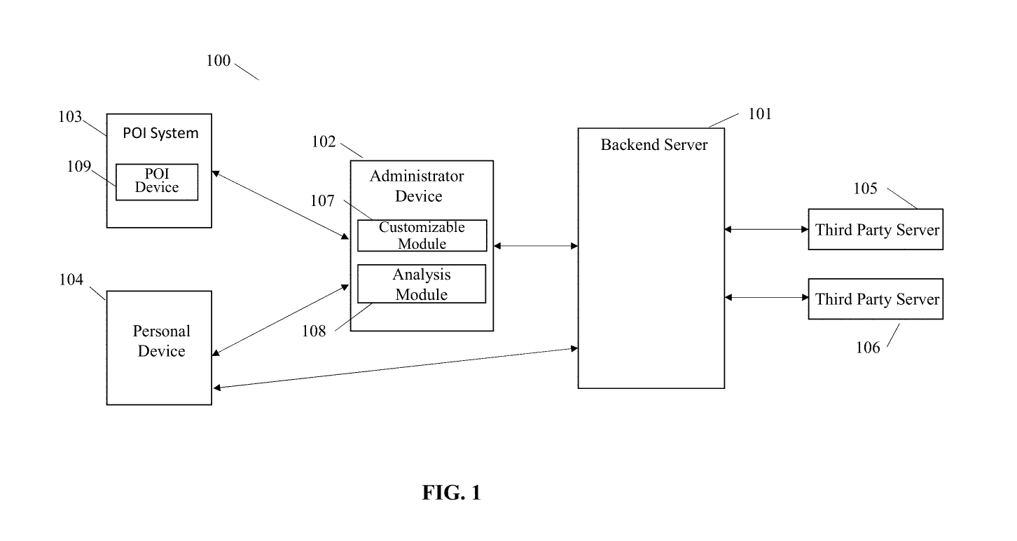

Referring now to the figures, various exemplary embodiments of systems for determining mission readiness and methods thereof will be described. Referring now to FIG. 1, an exemplary system 100 for creating one or more lines for a place of interest is provided. The system can include a backend server 101, an administrative device 102, a place of interest 103, and one or more personal devices 104. Although not depicted, a backend system can comprise the backend server 101 and the administrator device 102.

The backend server 101 can be in communication with the administrator device 102 over a private network. As such, the communication between the backend server 101 and the administrator device can be provided over a secure network. Along these lines, the administrator device 102 can only be accessed by an administrator having authorized credentials. To do so, the administrator device 102 can require a username and password. Moreover, the backend server 101 can be in communication with the user device 104 over a public network. However, although not illustrated, the system 100 can include a firewall to prevent unauthorized access from the user device 104 to the backend server 101. As to the administrator device 102, it can be in communication with the place of interest over a private or public network, and it can be in communication with the personal device 104 over a public network.

The backend server 101 can be in communication with one or more third party servers 105, 106. For example, one third party server may be that of a web mapping service. As will be described later, this can be utilized to provide a map with one or more points of interest to a user on a personal device. Along these lines, another third party server may be that of a source providing readily available location information of one or more individuals about a place of interest. This can provide the backend server 101 another way to determine individuals physically present in a line at the place of interest.

The backend server 101 can be in communication with the personal device to track a location an individual using the personal device 104. To do so, the backend server 101 can receive a location of the individual using of the personal device 104 having an active global positioning system (GPS) and/or Bluetooth technology. In doing so, the backend server 101 can determine a number of individuals physically waiting in line at any given point. For example, when first individual requests entry into a virtual line at a place of interest and no virtual line exists for the place of interest, the backend server 101 can determine the number of individuals physically waiting in line at that given point based on the number of personal devices 104. Along these lines, the backend server 101 can determine a number of people using personal devices 104 entering and exiting the place of interest over a period of time.

In addition, the backend server 101 can be in communication with the personal device 104 to receive input from the individual operating the personal device 104. As such, the backend server 101 can receive data directly from the individual waiting in line on data relating to wait time of the line at the place of interest and/or any other information affecting their wait time. Moreover, the backend server 101 receiving historical data of the line from the place of interest or an external source (not illustrated).

Accordingly, by being in communication with the personal devices 104 and third party servers 105, 106, the backend server 101 can determine behavioral traits of an average individual for a place of interest. Further, the backend server 101 can determine an average person's willingness to wait at various periods of times, and/or at different days of the week, for the place of interest. Moreover, the backend server 101 can determine the frequency of reentry of individuals into the place of interest and their churn rate. The place of interest can assess such behavior traits on-demand at any point in time.

The administrator device 102 can comprise a customizable module 107 to create one or more virtual lines, one or more processes, and/or one or more schemes, which will each be discussed in more detail below. Upon creation, the administrator device 102 can be in communication and send data to the backend server 101 for analysis. The administrator device 102 can also be in communication with the POI system 103 and/or the personal device 104 to receive and process the creation and/or updating of the virtual line. According to an embodiment, the administrator device 102 can send one or more updates to an individual waiting in a virtual line. According to another embodiment, the administrator device 102 can permit the POI system 103 to send one or more updates to an individual waiting in a virtual line. For example, the administrator device 102 and/or POI system 103 can send an individual an update on an amount of time until they are in the front of the line. The administrator device and/or POI can also send an update on an amount of time until they have to at the POI to secure their place in line, or they will lose their place in line. The update can be done by a text message and/or push notification.

Upon receiving an individual's request for entry into the virtual line, the administrator device 102 can comprise an analysis module 108 to receive virtual line data, process data, and/or scheme data from the backend server 101. In doing so, the analysis module 108 can create and/or update the virtual line for an appropriate place in the virtual line for the individual. Although illustrated as part of the administrator device 102, the analysis module 102 can be part of the POI system 103. The POI system 103 can receive permission from the administrator device 102 to create and/or update the virtual line for an individual based on the creation of the line, process and scheme of the customizable module 107 of the administrator device 102.

Regarding the place of interest (POI) system 103, it can be in communication with the administrator to receive virtual line, process, and/or scheme created by the administrator device 102. The POI system 103 can determine a checking-in and/or checking-out time of one or more individuals at the POI. This can be utilized to determine a congestion indication, such as an average time of an individual at the receptionist. In other words, the congestion indication of the POI can be based on the check-in and/or check-out time of the receptionist.

Moreover, the POI system 103 can comprise one or more POI devices 109. The POI device 109 can by any type of computing device that can be any type of computing device in the possession of the place of interest. According to an embodiment, a first POI device 109 can be an electronic device operated by an individual personally requesting entry to a virtual line. For example, the first POI device can be a kiosk or another type of electronic device to be operated by the individual personally such as smart device (i.e., smart phone). According to another embodiment, a second POI device 109 can be an electronic device operated by an authorized operator requesting entry to a virtual line on behalf of an individual. For example, the second POI device 109 can be a handheld computer operated by the authorized operator. According to yet another embodiment, a third POI device 109 can be a point-of-sale device, such as a register, that a consumer uses to pay for a service. As such, the third POI device 109 can be in communication with the administration device 102 and/or POI system 103 for analysis, such as to determine a check-in and check-out time of an average individual using the third POI device. According to yet a further embodiment, a fourth POI device 109 can be a beacon device to triangulate a position of an individual at a place of interest. According to yet another embodiment, a fifth POI device 109 can be a device utilized to detect a matrix or two-dimensional barcode, such as a QR code, from a personal device 103. This can be utilized to show the POI system 103 that an individual who previously requested a place in line is present at the POI.

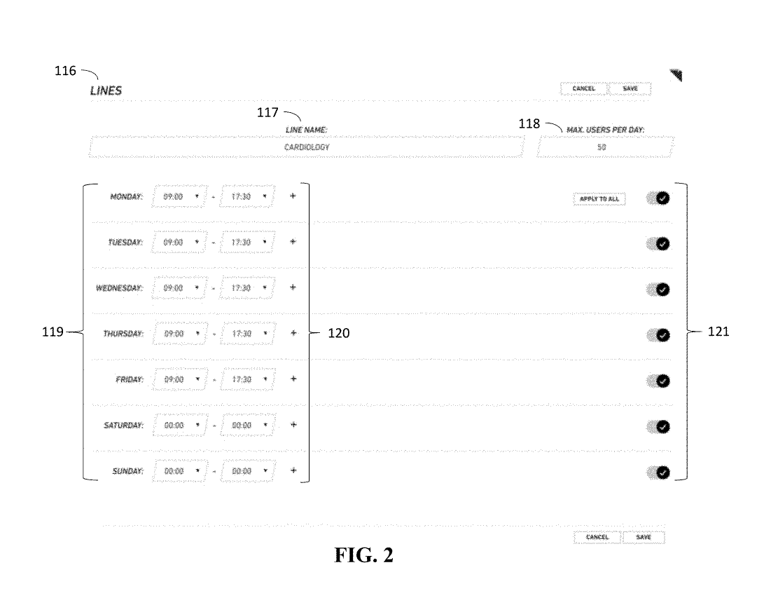

Referring now to FIG. 2, an exemplary user interface 116 for an administrator at the administrator device 102 (illustrated in FIG. 1) to create a virtual line is illustrated. The administrator can enter a virtual line name 117 and a maximum number of individuals who may enter the virtual line per day 118. The administrator can also specify the days 119 and/or time of the day 120 that the individual may enter the virtual line. In an embodiment, although not illustrated, the administrator can specify different internals of time within a particular day that the line is open. Moreover, the administrator can activate/deactivate 121 admission into the virtual line on a particular day 121 and/or interval 120.

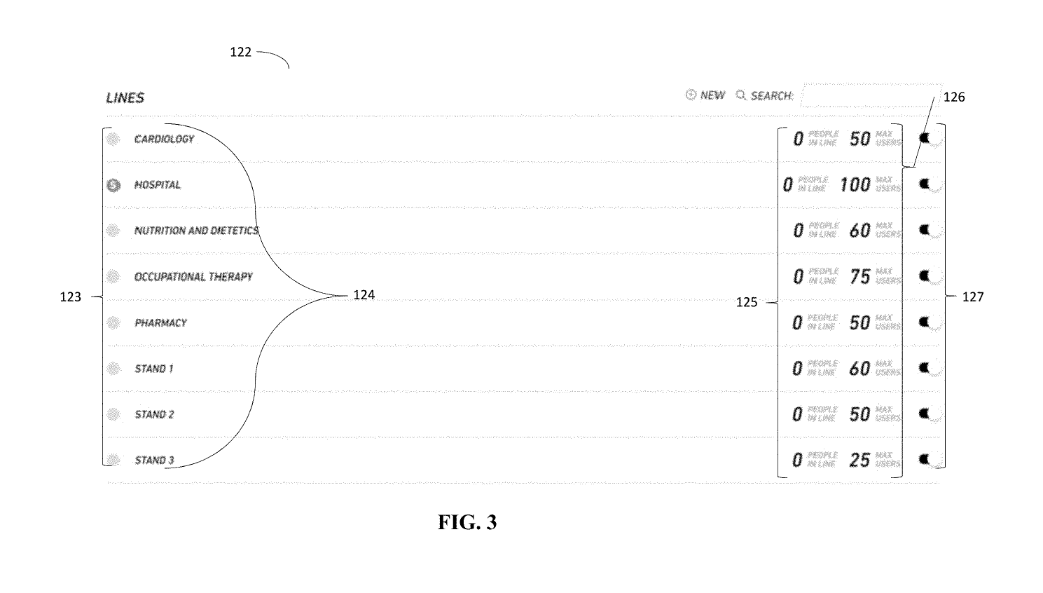

Referring now to FIG. 3, an exemplary user interface 122 for an administrator at the administrator device 102 (illustrated in FIG. 1) to view a plurality of virtual lines 123 created for a plurality of place of interests is illustrated. The user interface 122 can present a symbol 124 representing a congestion indication of the place of interest. In a virtual line, the congestion indication can relate to the number of people waiting in the virtual line, not in a physical line. As such, the congestion indication can be determined based on a rolling average of time an individual waits in the virtual line. For example, if three individuals have waiting times of 5, 10, and 15 minutes, respectively, moving forward, the rolling average of time for an individual in the virtual line will be 10 minutes

As will be discussed below, a virtual line is created to be utilized by a place of interest

The symbol 124 can be one of a plurality of possible symbols. As such, the symbol 124 can be a color-coded circle. For instance, the color red can refer to a very congested virtual line, the color yellow can refer to a somewhat congested virtual line, and the color green can refer to a line that is not congested. The color of the symbol can based on different thresholds which can be adjusted by the administrator at the administrator device 102 (illustrated in FIG. 1) and/or by an authorized user at the POI system (illustrated in FIG. 1). Along these lines, the thresholds for the symbols 124 can be different based on the industry. For example, for a line at a sporting event, the color red can refer to a wait time of greater than one hour, the color yellow can refer to a wait time greater than 30 minutes and less than one hour, and the color green can refer to a wait time under 30 minutes. Alternatively, for a line in a hospital, the color red can refer to a wait time of greater than 30 minutes, the color yellow can refer to a wait time greater than 15 minutes and less than 30 minutes, and the color green can refer to a wait time under 15 minutes. Further, the user interface 122 can permit entry of a max number of people for each virtual line 126. Moreover, the user interface 122 can permit an administrator to activate/deactivate 127 admission into each virtual line.

As illustrated, FIG. 3 depicts the “cardiology,” “nutrition and dietetics,” “occupational therapy,” “pharmacy,” “stand 1,” “stand 2,” and “stand 3” lines. The “cardiology” line, the “nutrition and dietetics” line, the “occupational therapy” line, and the “pharmacy” line each belong to a hospital (a place of interest). The “stand 1” line, the “stand 2” line, and the “stand 3” line belong to a stadium (a place of interest).

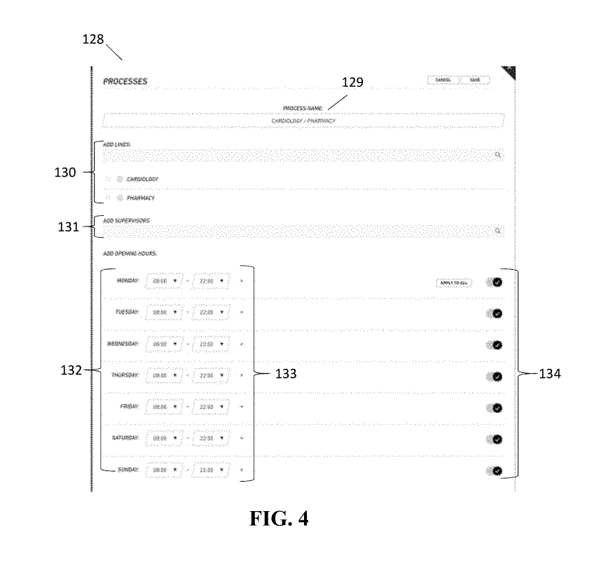

Referring now to FIG. 4, an exemplary user interface 128 for an administrator at the administrator device 102 (illustrated in FIG. 1) to create one or more processes 129 for a place of interest is illustrated. The process 129 can be utilized for a first service that requires an individual to go through more than one line in a sequential order. As such, the administrator can add a plurality of lines 130 to a particular process and indicate in which line to enter first. By doing so, the lines 130 can act dependent of each other. For example, as illustrated, the administrator can create the “Cardiology/Pharmacy” process in which users are go through the “Cardiology” line, and thereafter, go through the “Pharmacy” line. Along these lines, in an embodiment, upon an individual going through the first line, the administrator device 102 (illustrated in FIG. 1) can place them at the end of the second line. In another embodiment, upon an individual going through the first line, the administrator device can place the individual at the front of the second line.

Moreover, the administrator can add one or more supervisors 131 to monitor the process, and although not illustrated, can enter a number of individuals permitted to enter the lines in the process. Further, the administrator can also specify the days 132 and/or time of the day 133 that the individual may enter the virtual line. In an embodiment, although not illustrated, the administrator can specify different internals of time within a particular day that the line is open. The administrator can also activate/deactivate 134 admission into the virtual line on a particular day and/or interval.

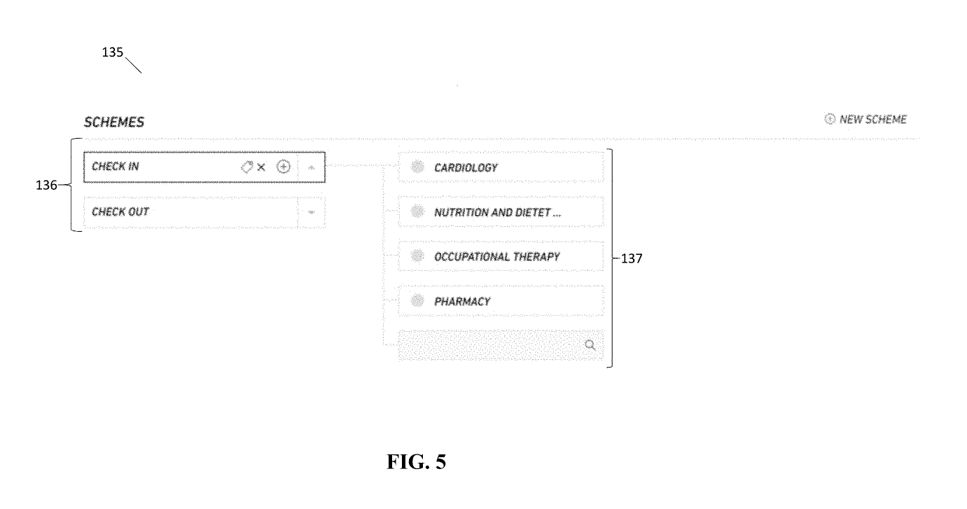

Referring now to FIG. 5, an exemplary user interface 135 for an administrator at the administrator device 102 (illustrated in FIG. 1) to create a scheme 136 for one or more lines at a place of interest is illustrated. As such, the administrator can provide authorization of one or more created lines or processes, as discussed above. The authorization can be provided to a particular POI device 109 (illustrated in FIG. 1) or individual at the POI. For example, one line can be provided at a POI device, and another line can be provided at a different POI device. Also, for example, one scheme—containing multiple lines—can be provided at a POI device, and only another line can be provided at a different POI device.

Along these lines, the administrator at the administrator device 102 (illustrated in FIG. 1) may only provide certain privileges to an individual operating a personal device 104 or to an authorized user of a POI device 109. The administrator may only permit an individual using a personal device 104 (illustrated in FIG. 1) to enter a second line—subsequent to a first line—at the POI. Along these lines, the administrator at the administrator device 102 (illustrated in FIG. 1) may only permit an authorized user of a POI device to enter an individual into such a second line. As such, although the individual can enter the first line from outside of the place of interest and through their personal device 104, the individual can only enter the second line from the POI device 109, personally or through an authorized user of the POI device 109, located at the place of interest. In contrast, the administrator at the administrator device 102 may only permit an individual using a personal device 104, or an authorized user of a POI device 109, to enter a first line—prior to a second line—from the POI. As such, although the user can access the second line outside of the place of interest and through their personal device 104, the user can only enter the first line from the POI device 109 located at the place of interest.

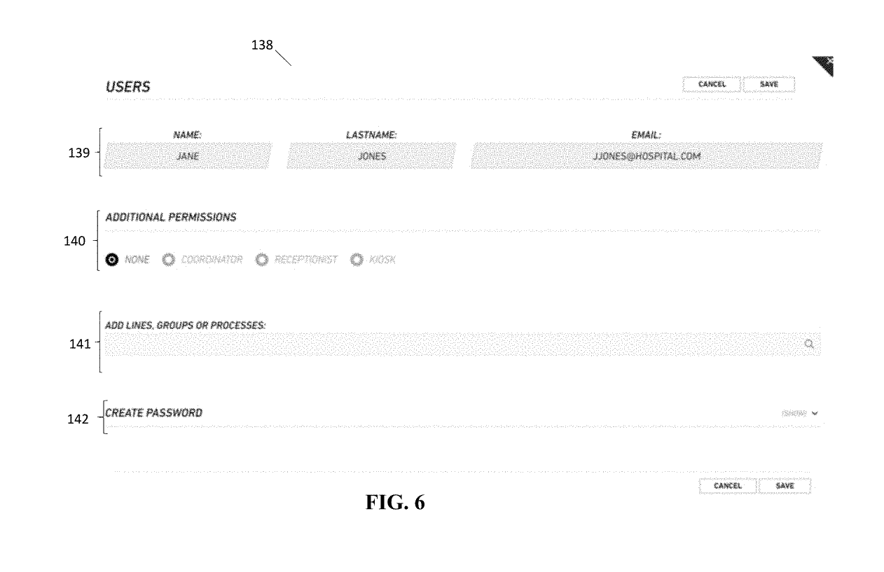

Referring now to FIG. 6, an exemplary user interface 138 for an administrator at the administrator device 102 (illustrated in FIG. 1) to assign one or more lines, groups, and/or processes at a place of interest to a user is illustrated. The administrator can enter identifying information 139 for the user, such as first name, last name, and/or email address. The administrator can also create a password 142 for the user. Additionally, the administrator can assign permissions 140, and can assign lines, groups or processes 141. As illustrated, the permissions can be a coordinator, receptionist, or kiosk.

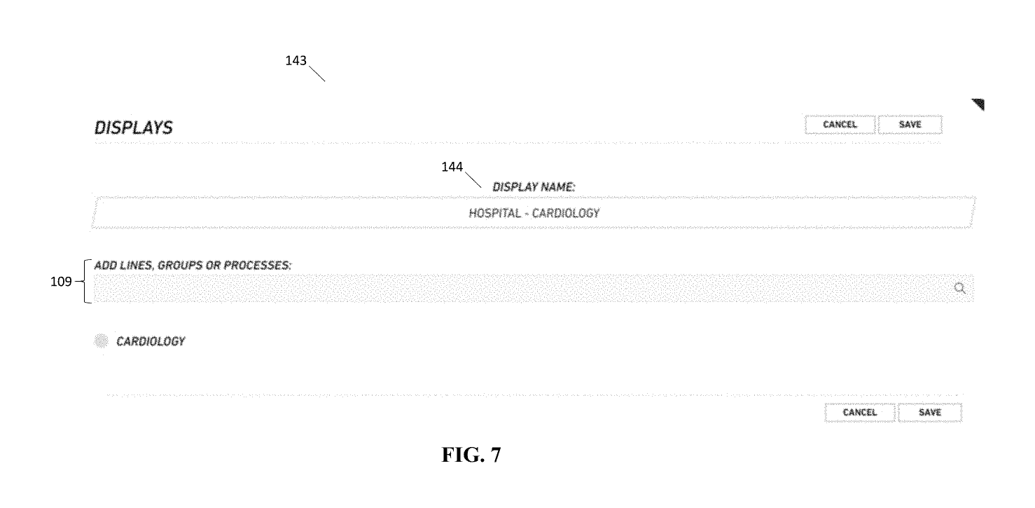

Referring now to FIG. 7, an exemplary user interface 143 for an administrator at the administrator device 102 (illustrated in FIG. 1) to assign one or more lines and/or processes at a place of interest to a display screen is illustrated. The user interface 143 can permit an administrator to enter a display name 144, and can permit an administrator to add one or more lines, groups, and/or processes 109. As illustrated, the display screen “Hospital—Cardiology” can present the “Cardiology” line.

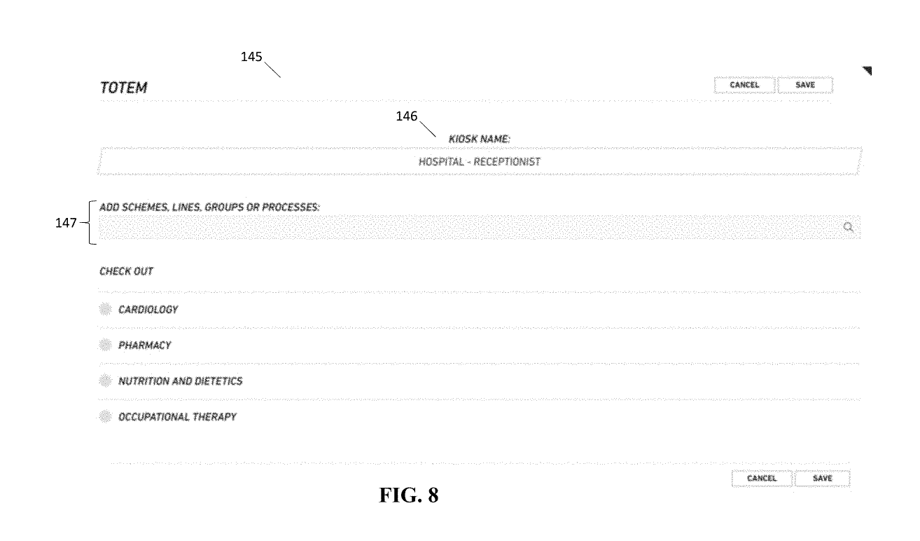

Referring now to FIG. 8, an exemplary user interface 145 for an administrator at the administrator device 102 (illustrated in FIG. 1) to assign one or more lines, groups, and/or processes at a place of interest to a POI device 109 (illustrated in FIG. 1) is illustrated. The administrator can create a name for the POI device. The name can refer to place of interest and/or location of the POI device. For instance, as illustrated, the name can be “Hospital—Receptionist.” Moreover, the user interface 145 can permit an administrator to add one or more lines, groups, and/or processes 147. As illustrated, the “Hospital—Receptionist” Kiosk can implement the “Check Out” scheme, and can display the “Cardiology,” “Pharmacy,” “Nutrition and Dietetics,” and “Occupational Therapy” lines.

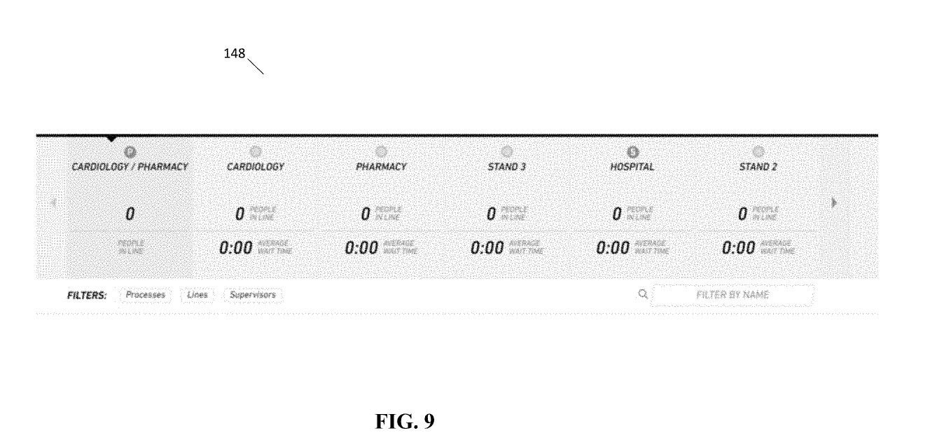

Referring back to FIG. 1, as discussed above, the POI 109 device can be any type of computing device in the possession of the place of interest that can be operated by an authorized operator of the POI or an individual themselves. As such, referring now to FIGS. 9-11, exemplary user interfaces of a POI device (illustrated in FIG. 1) operated by an authorized operator requesting entry to a virtual line on behalf of an individual, or by the individual themselves, is illustrated. Referring now to FIG. 9, a user interface 148 can initially include each created process and line. The user interface 148 can permit the authorized user to filter the processes and lines by processes, lines, supervisors, and/or name. For each process/line, the user interface can present a current status of congestion, a number of people in line, and an average waiting time. As discussed above, congestion indication can be based on one of or more of: the third party server 105, 106 providing readily available location information of one or more individuals, the backend server 101 receiving a location of a personal device having an activate GPS, the backend server 101 receiving input from an individual using the personal device 104, and the backend server 101 receiving historical data relating to the waiting time of the line from the place of interest or an external source (each illustrated FIG. 1). The symbol 124 can be a color-coded circle, and can change colors based on the amount of congestion as described above.

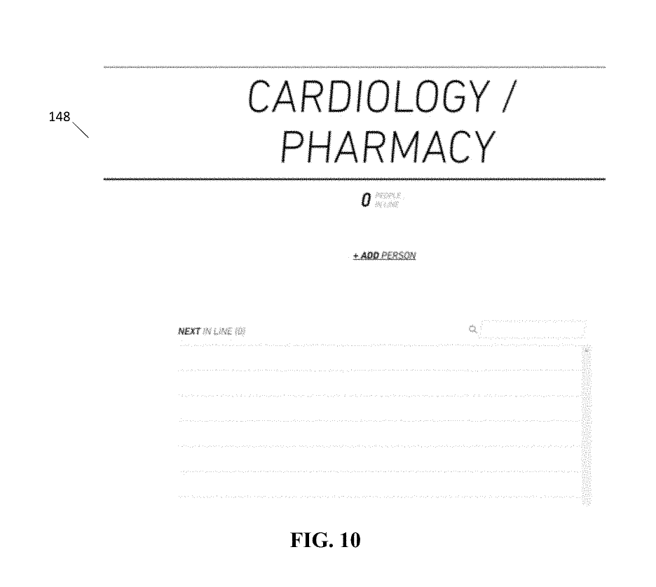

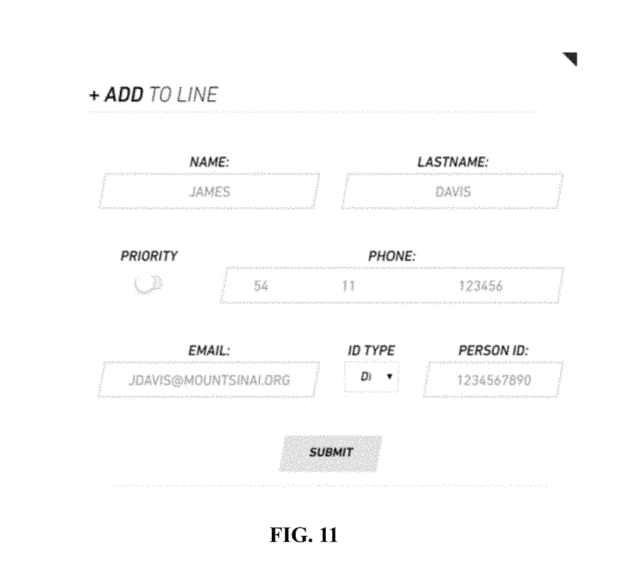

Moreover, referring now to FIG. 10, upon selection of a process or line, the user interface 148 can present a list of the individuals in line, and can allow the authorized user to add an individual. Thereafter, referring now to FIG. 11, the authorized user can then add identifying information of the individual. For instance, the identifying information for the individual user can add one of more of a first name, last name, phone number, email address, identification (ID) type, and personal ID. The authorized user can also indicate a priority for the individual. The priority can decrease the wait time for the individual.

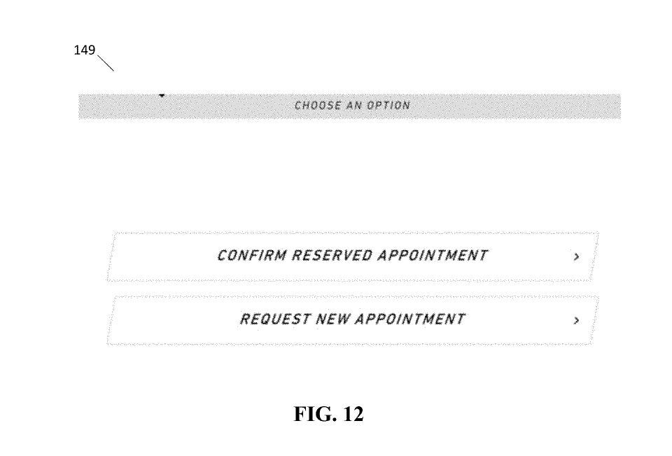

Referring now to FIGS. 12-14, exemplary user interfaces of a POI device (illustrated in FIG. 1) operated by an individual requesting entry into a virtual line is illustrated. Referring now to FIG. 12, a user interface 149 can permit the individual to confirm a reserved appointment or to request a new appointment. The reserved appointment may refer to a request for entry into a virtual line made on a personal device. The new appointment may refer to a new request for entry into a virtual line not made previously, such as on a personal device. Although not depicted, upon selection of confirming a reserved appointment, the individual can be prompted to enter identifying information. The identifying information can include one or more of a first name, last name, document type, document number, and appointment ID.

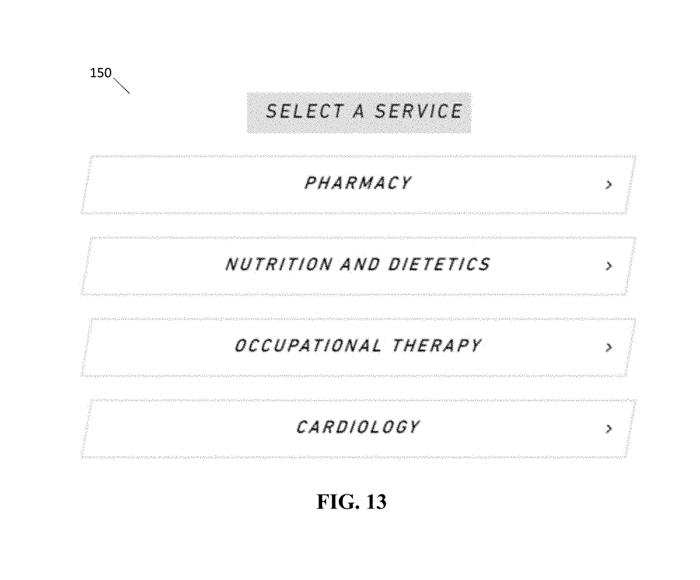

Referring now FIG. 13, upon selection of request a new appointment, a user interface 150 can present one or more services for an individual to select. The service can be one or more processes and/or one or more lines. If one or more schemes is created, they are presented for selection, and thereafter, the lines relating thereto can be presented for selection.

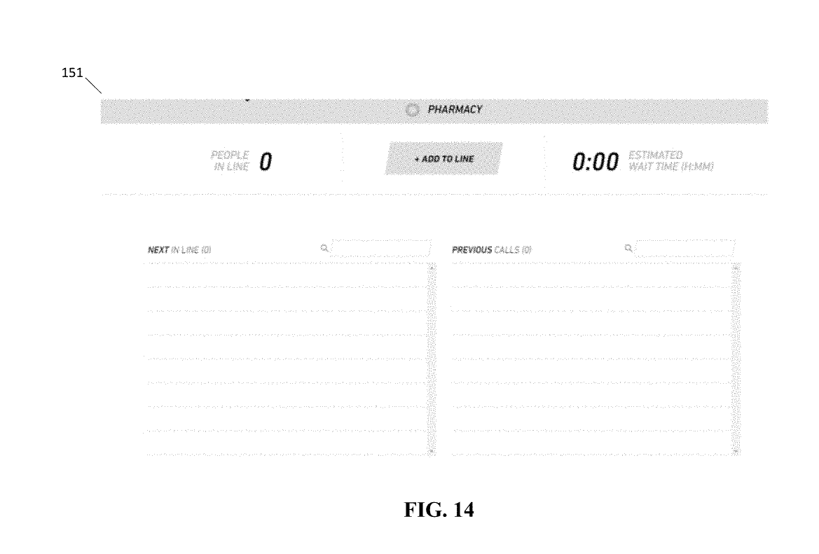

Referring now to FIG. 14, upon selection of a line, a user interface 151 can present status information of the line. The status information can include a current status of congestion, a number of individuals in the virtual line, an estimate wait time for an individual in the virtual line, a list of the next individuals in the virtual line, and/or a list of previous individuals called. The user interface 151 can also permit the individual an opportunity to enter the virtual line. To do so, the individual must enter identifying information. The identifying information can be one of more of a first name, last name, phone number, email address, identification (ID) type, and personal ID. The authorized user can also indicate a priority for the individual.

Referring back to FIG. 1, the personal device 104 can be any computing device belong to a private user. For instance, the personal device 104 can be a mobile telephone, a laptop, tablet, or desktop computer, a netbook, and a smart phone. To enter the virtual line, the personal device 104 can request a username and password. To do so, the personal device 104 can request a user to create a profile. To expedite this process, the personal device 104 can link to a profile, such as social media or email profile, and request the associated username and password. By doing so, the personal device can automatically retrieve profile information for the individual.

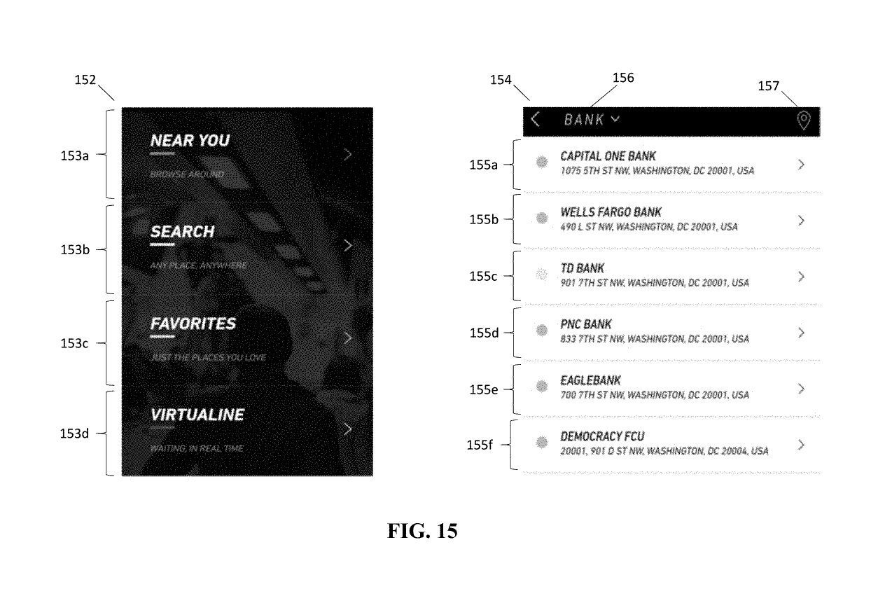

Referring now to FIGS. 15-20, exemplary user interfaces for an individual operating a personal device 104 (illustrated in FIG. 1) to request a virtual line is illustrated. Referring now to FIG. 15, a user interface 152 can provide one or more features 153a-d. As illustrated, the features 153a-d can be “Near You,” “Search,” “Favorites,” and “Virtualine.” The “Near You” feature 153a can permit an individual to search for one or more places of interest in proximity to the individual. The “Search” feature 153b can permit an individual to search for one or more places anywhere around the world. The “Favorites” feature 154c can permit an individual to have quick access to one or more of their favorite virtual lines and/or places of interest. The “Virtualine” feature 154d can permit an individual to enter a virtual line at a place of interest.

Upon selection of the “Near You” feature 153a, a user interface 154 can present an individual with one or more places of interest 155 for a particular category 156. As such, the feature “Near You” 153a can utilize the GPS feature of the personal device 104 (illustrated in FIG. 1) to determine one or more places of interest 155 within a predetermined distance. The predetermined distance may be defined by an administrator at the administrator device 102 (illustrate in FIG. 1), or by the individual operating the personal device 104.

The user interface 154 can permit the individual to change the category 156 to one of a plurality of categories. For instance, although not illustrated, the categories that can include “Amusement Park,” “Cafe,” “Furniture Store,” “Pharmacy,” etc. Upon selection of any one of these categories, one or more places of interest relating to the selected category can be presented. Here, the category selection of “Bank” 156 results in the “Capital One Bank,” “Well Fargo Bank,” “TD Bank,” “PNC Bank,” EagleBank,” and “Democracy FCU” points of interests 155a-f being presented.

For each place of interest 155a-f, the user interface 154 can include an address of the place of interest. The user interface 154 can also include a symbol representing the current congestion at the place of interest. For instance, the symbol 124 can be a color-coded circle, and can change colors based on the amount of congestion. As such, the user interface 154 can permit an individual to select one of the places of interest 155a-f.

Further, the user interface 154 can permit selection of a map icon 157 to view the places of interest on a geographical map surrounding the individual. As described above, the map and places of interest to be presented on the map can be provided by the backend server 101 which can receive such geographical information from a third party server 105, 106 (illustrated in FIG. 1).

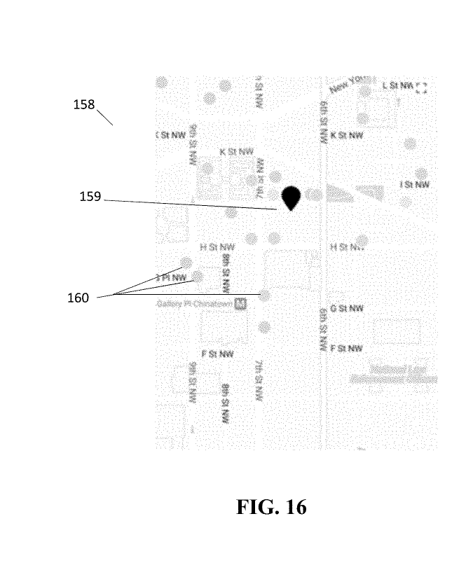

Referring now to FIG. 16, upon selection of the map icon 157 (illustrated in FIG. 15), the personal device 104 (illustrated in FIG. 1) can present a geographical map 158 containing the places of interest 155a-f (illustrated in FIG. 15). The geographical map 158 can illustrate an icon 159 representing a geographical location of the individual. The places of interest 155a-f (illustrated in FIG. 15) can be presented on the geographical map 158 with solely a symbol 160 representing the current status of congestion. Accordingly, the geographical map 158 can provide a symbol for a first place of interest having a virtual line, as well as a symbol for second place of interest not having a virtual line. As discussed above, the symbol 160 for the places of interest can be one of a plurality of possibilities. The symbol 160 can also represent the current status of congestions at the place of interest. As such, places of interest having a virtual line and not having a virtual line can share one or more symbols, as will be discussed in more detail below. Moreover, the geographical map can 158 can permit an individual to move within the map. As such, the individual can move outside of the predetermined distance from their location. Upon doing so, the geographical map can populate one or more additional places of interest.

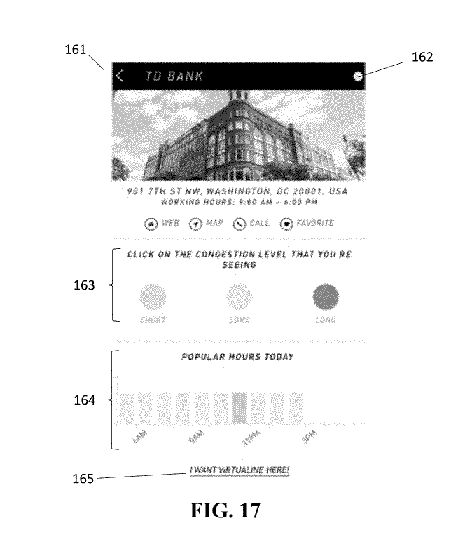

Referring now to FIG. 17, upon selection of a place of interest not having a virtual line, a user interface 161 may allow the user to assist in determining the congestion indication. In doing so, the user interface 161 may present information acquired by one or more third party servers 105, 106. The user interface 161 may one or more of a name of the place of interest, an address of the place of interest, a link to website of the place of interest, a link to a map of a place of interest, a link to call the place of interest, a link to “favorite” the place of business.

The user interface 161 can also a previously determined congestion symbol 162 and a plurality of possible congestion symbols 163. The previously determined congestion symbol 162 can be the same congestion symbol illustrated in the geographical map 158 (illustrated in FIG. 16). The previously determined congestion symbol 162 can be one of the plurality of possible symbols, and as stated above, can be a color-coded symbol reflective of the amount of congestion at the place of interest. As such, the previously determined congestion symbol 162 can be based on one or more of the third party server 105, 106 providing readily available location information of one or more individuals, the backend server 101 receiving a location of a personal device having an active GPS and/or bluetooth, the backend server 101 receiving input from individual using the personal device 104, and the backend server 101 receiving historical data of the line from the place of interest or an external source (each illustrated FIG. 1). Accordingly, symbol having the color red can refer to a very congested virtual line, yellow can refer to a somewhat congested virtual line, symbol having the color green can refer to a line that is not congested, and symbol having the color gray can refer to data not yet being analyzed. Also, it should be noted that congestion, and symbols relating thereto, can refer to an amount of people at the place of interest and/or a time an average person spends at the place of interest.

The possible congestion symbols 163 can relate to a congestion that an individual at a place of interest is experiencing. The possible congestion symbols 163 can be a plurality of the possible symbol discussed above. For instance, the colors red, yellow, and green can be presented to the user to indicate the level of congestion. As such, the user interface 161 can permit the individual to select the symbol that correctly reflects the congestion they are experiencing. In doing so, the previously determined symbol 162 can be updated accordingly.

Moreover, the user interface 161 can present one or more popular hours of the day 160. The popular hours of the day 164 can relate to the hours of the days individuals prefer to visit the place of interest. As illustrated, the popular hours of the day 164 can be presented in the form of a bar graph. As such, each hour of the day can have its own bar. Thus, the bar for each hour of the day can have a length reflective of the congestion that hour, and/or can be color-coded based on the amount of congestion for the hour in accordance with the color schemes discussed above.

The user interface 161 can also allow the user to request a virtual line to be at the place of interest. Accordingly, if no individuals are presently in a virtual line, the backend server 101 (illustrated in FIG. 1) can create a virtual line for an individual to enter at be placed in a queue. In doing so, the place of interest will have a separate line for the virtual line than those individuals waiting at the place of interest physically in line. As such, the first person requesting the virtual line will be the first in the queue, irrespective of the number of individuals physically waiting in line at the place of interest. Alternatively, although not illustrated, when the place of interest already has a virtual line, the user interface 158 can permit the individual to request entry into the virtual line.

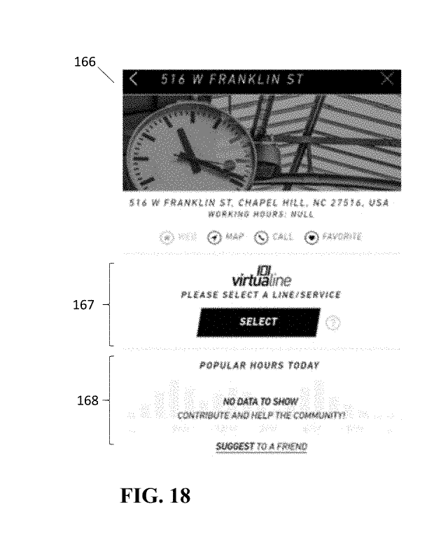

Referring now to FIG. 18, upon selection of a place of interest having a virtual line, a user interface 166 may present a congestion indication and permit an individual to enter the virtual line. The user interface 166 may one or more of a name of the place of interest, an address of the place of interest, a link to website of the place of interest, a link to a map of a place of interest, a link to call the place of interest, a link to “favorite” the place of business. The user interface can 166 can also permit the individual to enter the virtual line 167.

Moreover, the user interface 166 can present one or more popular hours of the day 160. The popular hours of the day 168 can relate to the hours of the days individuals prefer to visit the place of interest. As illustrated, the popular hours of the day 168 can be presented in the form of a bar graph. As such, each hour of the day can have its own bar. Thus, the bar for each hour of the day can have a length reflective of the congestion that hour, and/or can be color-coded based on the amount of congestion for the hour in accordance with the color schemes discussed above.

Although not illustrated, the user interface can present one of a plurality of possible congestion symbols. As stated above, and like the symbols presented for a place of interest not having a virtual line, the possible congestion symbols can be a color-coded symbol reflective of the amount of congestion at the place of interest. For instance, also like the symbols presented for a place of interest not having a virtual line, the symbol can be one of the color red to refer to a very congested virtual line, yellow to refer to a somewhat congested virtual line, color green can refer to refer to a line that is not congested. Also, it should be noted that congestion, and symbols relating thereto, can refer to an amount of people at the place of interest and/or a time an average person spends at the place of interest.

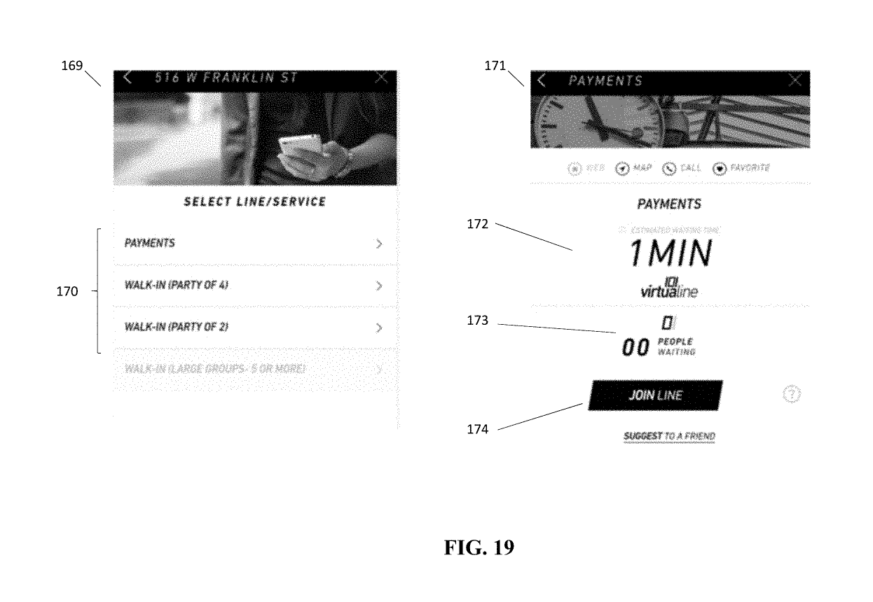

Referring now to FIG. 19, upon selection of a request to join a line 167 (illustrated in FIG. 18), a user interface 169 can present one or more lines 170 available for an individual to join. Upon selection of a line, a user interface 171 can present an estimated waiting time 172, a number of people waiting in line 173, and an option to join the line 174. Thereafter, although not illustrated, a user interface can be presented to allow an individual to leave the line and/or reset their place in line.

Referring back to FIG. 15, upon selection of the feature “Search” 153b, an individual can be presented with a map and a search bar to find one or more places of interest. Moreover, upon selection of the feature “Favorites” 153c, an individual can be presented with their favorite places of interest. As such, upon selection of a place of interest in the feature “Search” 153b and/or feature “Favorites” 153c, an individual can be presented with a user interface that is the same as the user interface 158 described above with respect to the feature “Near You” 153a.

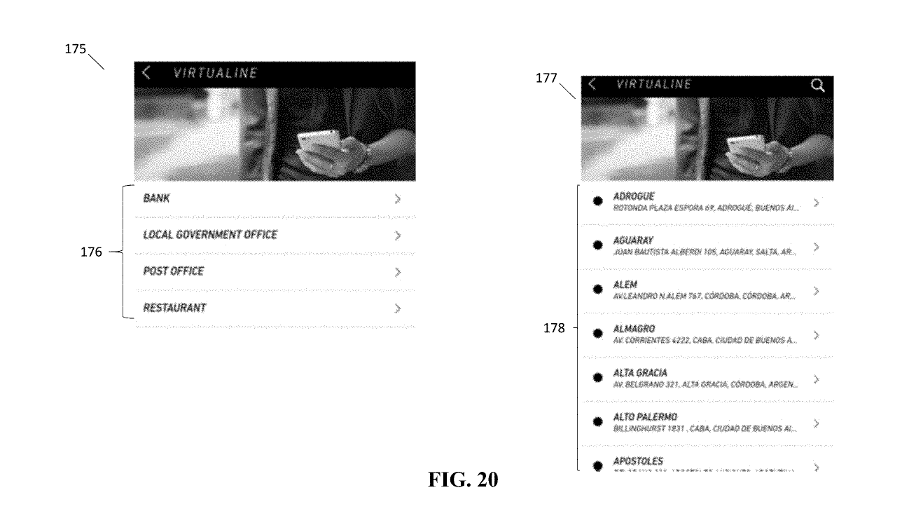

Further, upon selection of the feature “Virtualine” 153d, referring now to FIG. 20, a user interface 175 can present one or more categories 176 as described above with respect to FIG. 15. Thereafter, upon selection of a category, a user interface 177 can present one or more places of interest. Subsequently, upon a selection of a place of interest, a plurality of user interfaces as described in relation to FIGS. 18 and 19 can be presented to an individual to enter the virtual line.

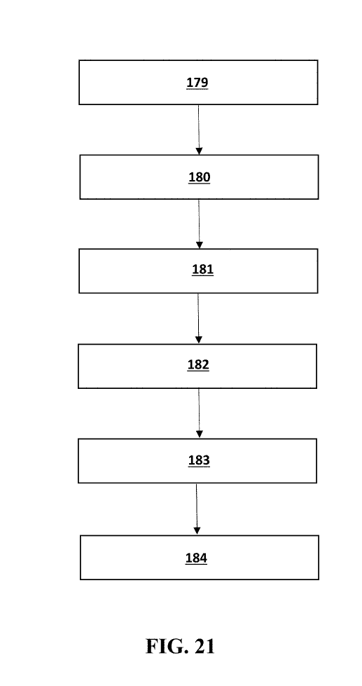

Referring now to FIG. 21, an exemplary method for creating a virtual line for a place of interest is provided. First, at bock 179, a first request to enter a virtual line at a place of interest from a first individual is received. Secondly, at block 180, the first individual is placed in the virtual line. Thereafter, at block 181, the virtual line with the first individual is created. Subsequently, at block 182, a check-in and check-out time of the first individual in the virtual line is determined. Next, at block 183, based on the check-in and check-out time, a congestion symbol of the virtual line is determined. Lastly, at block 184, the congestion symbol of the virtual line is presented to a second individual. Each of the aforementioned steps can be performed in accordance with embodiments of the invention as described above.

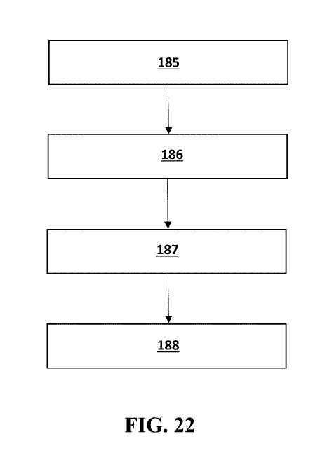

Referring now to FIG. 22, an exemplary method for presenting congestion of a line at a place of interest. First, at block 185, place of interest data for a first and second place of interest from a first external server is received. Secondly, at block 186, a request by an individual for a first congestion indication for a first line at the first place of interest to receive a second congestion indication for a second line at the second place of interest is received. Third, at block 187, the first congestion indication for the first line at the first place of interest and for the second line second place of interest is determined. Finally, at block 188, the first congestion indication of the first line at the first place of interest and the second congestion indication for the second line second place of interest is presented.

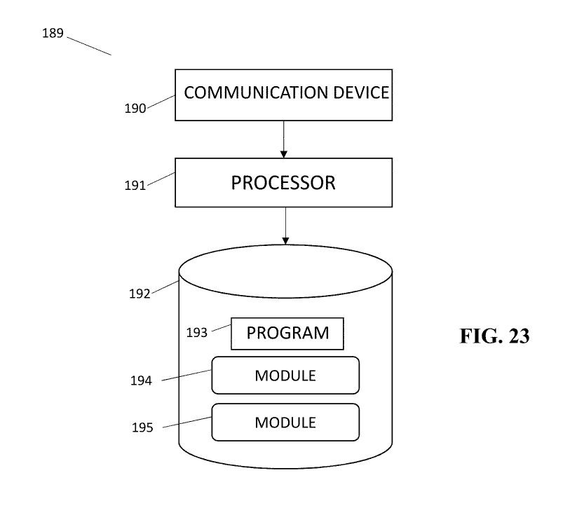

Referring now to FIG. 23, a schematic diagram of an exemplary server 189 that may be utilized in accordance with the present invention is illustrated. The exemplary server 189 includes a communication device 190, a processor 191, and a data storage or memory component 192. The processor 191 is in communication with both the communication device 190 and the memory component 192. The communication device 190 may be configured to communicate information via a communication channel, wired or wireless, to electronically transmit and receive digital data related to the functions discussed herein. The communication device 190 may also be used to communicate, for example, with one or more human readable display devices, such as, an LCD panel, an LED display or other display device or printer. The memory component 192 may comprise any appropriate information storage device, including combinations of magnetic storage devices (e.g., magnetic tape, radio frequency tags, and hard disk drives), optical storage devices, computer readable media, and/or semiconductor memory devices such as Random Access Memory (RAM) devices and Read-Only Memory (ROM) devices. The memory component 192 may store the program 193 for controlling the processor 191. The processor 191 performs instructions of the program 193, and thereby operates in accordance with the present invention.

The memory component 192 may also store and send all or some of the information sent to the processor 191 in a plurality of modules 194, 195. As such, the module 194, 195 may each store data relating to the third party servers 105, 106 (illustrated in FIG. 1), as well as the lines, processes, and schemes created by the administrator device 102, as discussed above. This can improve the logic and processing speed of the server 189 in creating a virtual line for a particular place of interest, as well as reduce the required computing power by the server 189 to do so.

Communication device 190 may include an input device including any mechanism or combination of mechanisms that permit an operator to input information to communication device 190, such as a keyboard, a mouse, a touch sensitive display device, a microphone, a pen-based pointing device, a biometric input device, and/or a voice recognition device. Communication device 190 may include an output device that can include any mechanism or combination of mechanisms that outputs information to the operator, including a display, a printer, a speaker, etc.

From the foregoing description, one skilled in the art can readily ascertain the essential characteristics of the invention, and without departing from the spirit and scope thereof, can make changes and modifications of the invention to adapt it to various conditions and to utilize the present invention to its fullest extent. The specific embodiments described here are to be construed as merely illustrative, and not limiting of the scope of the invention in any way whatsoever. Moreover, features described in connection with one embodiment of the invention may be used in conjunction with other embodiments, even if not explicitly stated above.

We claim:

1. A method for creating a virtual line for a place of interest, the method comprising:
receiving, by one or more computer, a first request to enter a virtual line at a place of interest from a first individual;
placing, by said computer, said first individual in said virtual line;
tracking, by said computer, a check-in and check-out time of said first individual in said virtual line;
determining, by said computer, based on said check-in and check-out time, a congestion symbol of said virtual line;
presenting, by said computer, said congestion symbol of said virtual line to a second individual.

2. The method of claim 1, wherein said first request from said first individual and said second request from said second individual are each from a device located at said place of interest.

3. The method of claim 1, wherein said first request from said first individual and said second request from said second individual are each from a personal device belonging said individual.

4. The method of claim 3, additionally comprising:
receiving, by said computer, geographical data for a region of interest surrounding said personal device of said first individual and second individual from an first external server; and
receiving, by said computer, place of interest data for said place of interest from an second external server.

5. The method of claim 4, additionally comprising:
creating, by said computer, based on said place of interest data and geographical data, a map containing said place of interest;
placing, by said computer, said congestion symbol to represent said place of interest on said;
sending, by said computer, said map with congestion symbol to said personal device of said first and second individual.

6. The method of claim 1, wherein said congestion symbol for a third individual entered into said virtual line comprises a rolling average of time said first individual and second individual waits ins aid virtual line.

7. The method of claim 1, additionally comprising:
presenting, by said computer, a number of individuals in said virtual line to said second individual.

8. The method of claim 1, wherein the virtual line is separate from a physical line at said place of interest.

9. A system for creating a virtual line for a place of interest, the system comprising:
an administrator device configured to:
receive a first request to enter a first virtual line at a place of interest from a first individual;
place said first individual in said first virtual line;
create said first virtual line with said first individual;
track a check-in and check-out time of said first individual in said first virtual line;
determine, based on said check-in and check-out time, a congestion symbol of said first virtual line;
present said congestion symbol of said first virtual line to a second individual.

10. The system of claim 9, additionally comprising:
a backend server in communication with the administrator device and configured to:
create a process for a plurality of virtual lines including said first virtual line, wherein the process provides an order for entering into said first virtual line prior to said second virtual line, and wherein entry into said second virtual line requires entry into said first virtual line.

11. The system of claim 10, wherein said backend server is further configured to:
receive geographical data for said place of interest from a first external serve;
receive place of interest data for said place of interest from an second external server;
create, based on said place of interest data and geographical data, a map containing said place of interest.

12. The system of claim 11, wherein the administrator device is configured to:
place said congestion symbol to represent said place of interest on said; and
send said map with congestion symbol to said personal device of said first and second individual.

13. The system of claim 9, wherein said congestion symbol for a third individual entered into said virtual line comprises a rolling average of time said first individual and second individual waits ins aid virtual line.

14. The system of claim 9, wherein said administrator device is configured to:
presenting, by said computer, a number of individuals in said virtual line to said second individual.

15. A method for presenting congestion of a line at a place of interest, the method comprising:
receiving, by one or more computers, place of interest data for a first and second place of interest from a first external server;
receiving, by said computer, a request by an individual for a first congestion indication for a first line at said first place of interest to receive a second congestion indication for a second line at said second place of interest;
determining, by said computer, said first congestion indication for said first line at said first place of interest and for said second line second place of interest; and
presenting, by said computer, said first congestion indication of said first line at said first place of interest and said second congestion indication for said second line second place of interest,
wherein said first line only has one or more individuals physically waiting in said first line, and
wherein said second line only has one or more individuals virtually waiting in said second line.

16. The method of claim 15, additionally comprising:
determining, by said computer, a location of said individual,
wherein said first and second places of interest are within a predetermined distance from said location of said individual.

17. The method of claim 16, additionally comprising:
receiving, by said computer, geographical data within said predetermined distance from said location of said individual from a second external server,
wherein said first and second congestion indication is presented on said geographical data.

18. The method of claim 17, wherein said congestion indication for said first line is based on historical data.

19. The method of claim 17, wherein said congestion indication for said first line is based on tracking of said one or more individuals physically in said first line.

20. The method of claim 17, wherein said congestion indication for said second line is based on an average waiting time of prior individuals waiting in said line.
